(19) United States
(12) Patent Application Publication
(10) Pub. No.: US 2021/0122187 A1
(43) Pub. Date: Apr. 29, 2021

(54) KIT AND METHOD FOR PREPARING A COLOURED SAMLE OF PAINT, VARNISH OR LACQUER

(71) Applicant: Emanuele STRADA, Ronco Sopra Ascona (CH)

(72) Inventor: Emanuele STRADA, Ronco Sopra Ascona (CH)

(21) Appl. No.: 16/635,765

(22) PCT Filed: Aug. 2, 2018
(86) PCT No.: PCT/IB2018/055805

§ 371 Date: Jan. 31, 2020

(30) Foreign Application Priority Data
Aug. 3, 2017 (IT) 102017000090061

(51) Int. Cl. B44D 3/00; B01F 13/10

(52) U.S. Cl. CPC B44D 3/003; B44D 3/08; B01F 13/105

(57) ABSTRACT

A kit, a method, and a coloring unit, for preparing a colored sample of paint, lacquer or varnish for the selection, by the user, of a desired color of a paint, lacquer or varnish to be applied to a wall or to a support, where the kit allows users to produce a reduced quantity of sample of paint, lacquer or varnish thanks to the possibility of employing specifically conceived pre-dosed coloring units, and thanks to the possibility of having available precise indications about the type and the quantity of coloring units to be added to the base paint, varnish or lacquer to obtain a determined color, also as a function of different quantities of the base paint, lacquer or varnish.

### TECHNICAL FIELD

The present disclosure refers to a kit, a method, and a coloring agent to be used in said method, for preparing a colored sample of paint, lacquer or varnish for the selection, by the user, of a desired color of a paint, lacquer or varnish, to be applied to a wall or to a support.

### BACKGROUND

In the sector of paints, there is a need, for operators, for example decorators or interior designers, but also for end users who want to proceed independently to the selection of the color of the paint, lacquer or varnish, to be applied, for example, to a wall of a house, or to any support to be colored, to be able to choose the desired color verifying the end result, for example in the case of paint for walls by directly applying a sample of said colored paint to the wall.

Typically, the choice is made among the colors present in specific decks or folders or collections of colors, for example among the colors offered by some standards, for example PANTONE, RAL, NCS and the like, or specific color collections.

After choosing one of the colors present in the range offered by said deck or folder or collection of colors, the chromatic and aesthetic outcome of the selected color is verified by applying a sample of paint, varnish or lacquer, to the desired support, for example making a panel of small dimensions on one of the walls or of the supports in question.

To obtain said color sample it is therefore necessary to purchase, at a paint factory or a specialized store, a can of paint, varnish or lacquer, varnish or lacquer of the selected color, which will be produced or supplied in the exact desired color identified by the color code, or by the color coordinates, or reference present on the deck/folder/collection of colors, and a colored quantity of paint, varnish or lacquer will be produced or supplied that is generally greater than the small quantity necessary to carry out the test on the wall that the user wants to perform.

This quantity of paint, varnish or lacquer of the specific selected color is obtained by the paint factory by means of automatic and/or manual machines that generally are not capable of making minimal doses. This limit is mainly due to the fact that the paint, varnish or lacquer of a specific color is obtained by mixing color pigments diluted in liquid form and added to a base paint, varnish or lacquer, which can be clear, white or already colored.

As is well known, both the minimum quantity of paint, lacquer or varnish, colored according to the desired sample color, and the hue of the color, are highly influenced by the difficulty of exactly dosing a minimal dose of pigment, generally diluted in liquid form.

More recently, attempts have been made to overcome the need for minimally dosing the color in a minimum quantity of neutral paint, varnish or lacquer, to obtain the correct color shade, using powdered pigments, in more or less concentrated form.

This method of coloring a paint, varnish or lacquer by adding powdered pigment in a neutral paint, varnish or lacquer, has limited feasibility. As is well known, powdered color pigments are extremely difficult to dose with precision because minimum quantities of pigments are able to color in a significant manner a neutral paint, varnish or lacquer, and therefore a different quantity of a few milligrams, or even less than one milligram, is sufficient to obtain even very different color gradations.

To overcome this difficulty, the adopted solution comprising dosing the pigments in a dose of a base paint, lacquer or varnish, neutral, white or already colored, that is greater than the actual needs for sampling, thereby scaling, and hence mitigating, the error due to the minimum dosage variations of the dyes; the resulting minimum dose of colored paint, colored lacquer or colored varnish obtainable will thus be, for example, 0.5 liters instead of a smaller quantity. The excess paint, varnish or lacquer generated will then constitute a cost and a waste of material. An additional problem comprising the correct repeatability/reproducibility of the colored paint, colored varnish or colored lacquer obtained, an effect of the technological limit of the aforementioned process.

If the user, upon sampling the panel with the selected color, realizes that once the color is applied and allowed to dry, is not of his/her liking in terms of color, hue and so on, it is necessary to repeat once or several times the entire cycle of selection and production of the sample paint, varnish or lacquer, still in higher quantities than necessary, with further waste of time and costs, and hence repeating again the operation of application to the wall and/or to the desired support.

All this is translated as said in long waiting times, high and unjustified costs, and waste of paint, varnish or lacquer.

To overcome these drawbacks, decorators can create the paint, the varnish or the lacquer of the desired color directly in place, for example through specific coloring kits useful to dose in a neutral, white or clear paint, lacquer or varnish, which serves as a base, some diluted pigments, for example in liquid form.

As has already been explained, dosing these pigments, albeit for example diluted in a liquid, remains a complex operation, and needs particularly costly equipment, such as precision/sensitive scales, or also for example specific dosing syringes or pistols. This procedure is complicated, dirtying, onerous in terms of time as well as poorly practical.

In addition to needing, as stated, the use of sensitive scales to proceed with a dosage by weight of the base coloring agents, the quantity of paint, varnish or lacquer obtained with these procedures is still greater than necessary because one has available coloring agents comprising pigments which in turn are diluted in liquid form, and therefore obtaining the desired color requires mixing the coloring agent containing the diluted pigment, in case of highly diluted pigment requiring also to provide high quantities of coloring agent in the liquid state, and this entails obtaining a high quantity of resulting colored paint, varnish or lacquer.

Moreover, an additional drawback of the system known in the state of the art comprising the difficulty of obtaining a paint, a varnish or a lacquer, colored with a color tint exactly corresponding to the desired one identified by the user among the standard colors present in the folders/decks/collections of existing colors, since although the pigments are diluted, dosing is never simple, and an even minimal difference in dosing the pigments significantly affects the hue of the color tint obtained.

The entire above description, and what will be described below, with reference to a paint, should be understood also to be extended to a varnish and/or to a lacquer.

### BRIEF SUMMARY

A specific task of the present disclosure is to overcome the drawbacks that afflict the known methods currently used for preparing a sample of colored paint, varnish or lacquer, in particular for the selection of a desired color of a paint, varnish or lacquer, to be applied to a wall or to a support, as well as to provide a kit for preparing said sample of colored paint, varnish or lacquer.

Within this task, a purpose of the present disclosure is to provide a kit and a method for preparing a sample of colored paint, varnish or lacquer that allow users to obtain easily and with full independence, in a reliable, reproducible and repeatable manner, and in the desired quantity, a sample of paint, varnish or lacquer having the specific desired color hue.

Another purpose of the present disclosure is to provide a kit, and a method, for preparing a sample of colored paint, colored varnish or colored lacquer that allow to obtain a sample of paint, varnish or lacquer having a color that faithfully matches the color selected on a deck of folder or list of colors or collection of colors or a digital color connection or digital list of colors in a reduced quantity.

Yet another purpose of the present disclosure is to provide a kit, and a method, for preparing a sample of colored paint, colored varnish or colored lacquer that can easily be modified by the user him/herself, easily obtaining different color hues.

Not the least purpose of the present disclosure is to provide a kit, and a method, for preparing a sample of colored paint, colored varnish or colored lacquer that provides for the use of coloring agents that are easily mixed with each other.

This task, as well as the aforementioned purposes and others that will be readily apparent farther on, are achieved by a kit for preparing a sample of colored paint, colored varnish or colored lacquer, particularly for selecting a desired color of a paint, varnish or lacquer, to be applied to a wall or to a support. Moreover, this task, as well as the aforementioned purposes and others that will be readily apparent farther on, are achieved by a method for preparing a sample of colored paint, varnish or lacquer, particularly for selecting a desired color of a paint, varnish or lacquer, to be applied to a wall or to a support.

Further features of the kit and of the method for preparing a sample of colored paint, colored varnish or colored lacquer according to the present disclosure are set forth in the dependent claims.

### DETAILED DESCRIPTION

The features and the advantages of the kit and of the method for preparing a sample of colored paint, varnish or lacquer according to the present disclosure will be more readily apparent from the following detailed description, provided by way of non-limiting example. The kit for preparing a sample of colored paint, varnish or lacquer, particularly for selecting a desired color of a paint, varnish or lacquer to be applied to a wall or to a support, according to the disclosure advantageously comprises a main container containing a known quantity of a base paint, a base varnish or a base lacquer to be colored, and a set of coloring units that can be mixed with said known quantity of base paint, varnish or lacquer for preparing a sample of colored paint, varnish or lacquer.

By way of example, a base paint, varnish or lacquer may then be in a neutral, clear, white color, or also in a primary or complementary color to which coloring units, for example pigments, can be added to obtain a final colored paint, colored varnish or colored lacquer of the desired hue.

Each of said coloring units comprising at least one pre-dosed unit, and said coloring units have a plurality of different colors.

The expression “pre-dosed unit” in the present description refers to an exact predetermined quantity of substance suitable to be employed as a discrete unit, i.e. to be used as a whole.

More in particular, each of said pre-dosed units will advantageously comprise a quantity that is pre-dosed in terms of weight and/or of volume of at least one coloring agent, for example a powdered color pigment.

For example, a set of colored units, pre-dosed in discrete predetermined quantities may be available, to be used whole, different from each other, for example in the form of blisters of tablets of 0.1 mg, 0.2 mg and so on.

Each of said pre-dosed units preferably comprises at least one coloring agent, for example a pigment, of pure or diluted color, in the form of powder, paste, in liquid form or the like.

Pre-dosed units comprising multiple coloring agents may equally be provided.

Preferably, each pre-dosed unit will comprise a powder tablet, pills, envelopes, openable capsules, pierceable capsules, a water-soluble support or any other form suitable to supply a pre-dosed quantity, in terms of weight and/or volume, of a coloring agent, for example a colored pigment, or multiple coloring agents, pure or diluted.

To enable the user to obtain a sample of paint, varnish or lacquer, of the desired color, previously selected for example from a deck of colors or the like, each pre-dosed unit is advantageously distinguished by a symbol and/or by a code and/or by a reference adapted to uniquely identify said specific unit.

For example, each pre-dosed unit may be identified by a letter and/or by the dosage, in terms of weight and/or by volume, thereof, so that according to the quantity of sample paint, lacquer or varnish the user wishes to obtain, the method according to the present disclosure will allow him/her to identify the specific pre-dosed units to be mixed to the neutral, white or already colored base paint, lacquer or varnish.

Advantageously, such pre-dosed units by volume and/or by weight, may be supplied, merely by way of example, in doses of 0.1 grams, 1 gram, 10 grams, or in doses of 0.1 ml, 1 ml, 10 ml and the like.

Alternatively, the pre-dosed units constituting said coloring units may all be supplied with the same dosage, and the method according to the disclosure will comprise mixing in said base paint, varnish or lacquer a different number of pre-dosed units according to the quantity of sample paint, varnish or lacquer to be obtained.

More specifically, the method for preparing a sample of colored paint, colored varnish or colored lacquer in particular for the selection of a desired color of a paint, varnish or lacquer, to be applied to a wall or to a support, according to the present disclosure, will preferably comprise the following steps comprising:
providing a main container containing a known amount of a base paint, varnish or lacquer to be colored;
providing a set of coloring units wherein each of said coloring units comprising at least one pre-dosed unit and wherein said coloring units have a plurality of different colors;
selecting one or more of said coloring units of said set as a function of the desired color for said colored paint, colored varnish or colored lacquer;
adding and mixing said one or more selected coloring units to said base paint, lacquer or varnish contained in said main container.

As stated, advantageously the method for preparing a sample of colored paint, lacquer or varnish according to the present disclosure, is characterized in that the step of selecting said one or more coloring units of said set of coloring units comprises a further step comprising previously identifying a plurality of sample colors, the sample colors can also refer to a sample that is not physical but digital or digitized, of associating to each of said sample colors a color code and/or reference code, and of univocally associating to each color code and/or reference code the number and the type of said pre-dosed units that have to be mixed to said base paint, lacquer or varnish to be colored.

The kit and the method for preparing a sample of paint, lacquer or varnish, colored according to the disclosure allow, through the precise dosage of the coloring units deriving from the use of pre-dosed units, to produce the sample of colored paint, colored varnish or colored lacquer mixing said coloring agents in a quantity of base paint, varnish or lacquer to be colored that is suited to the needs.

Preferably, the quantity of base paint, lacquer or varnish to be colored will be smaller than 500 ml, preferably equal to approximately 200 ml, still more preferably equal to approximately 100 ml.

In this way, one of the advantages of the disclosure is obtained, comprising avoiding the waste of a high quantity of base paint, lacquer or varnish if, upon completing the test, the user is not satisfied with the end result following the application of the sample paint, lacquer or varnish on the wall or on the support to be colored.

The present disclosure is characterized by the use of coloring units in the form of pre-dosed units that can be mixed with a base paint, lacquer or varnish for preparing a sample of colored paint, lacquer or varnish.

Said coloring unit advantageously comprising a pre-dosed unit, by weight and/or by volume, of at least one coloring agent, consisting for example of a pigment of a determined color or of a mixture of pigments of different colors.

Thus, the coloring unit will be univocally identifiable through a symbol and/or a code and/or a reference able to univocally identify said specific unit.

Purely by way of example, said pre-dosed unit comprising an exact predetermined quantity of substance to be used discretely, whole, can comprise a powder tablet, of an openable or pierceable capsule, of a sachet, of a water-soluble support or other types of formats/containers/supports for coloring agents such as a pigment or a mixture of multiple pigments.

The user will have available a predetermined correlation available for example on paper support/dedicated software application/specific software program, between the color code and/or reference associated to each color, also digitized, which the user will be able to identify for example on a deck of colors, also digitized and the specific color as well as the specific quantity, as well as possibly the specific dosage of said pre-dosed units, which the user will have to mix to the quantity of base paint, varnish or lacquer to obtain the desired colored sample paint, lacquer or varnish.

Said correlation may also indicate different quantities and dosages of the pre-dosed units as a function of different quantities of base paint, varnish or lacquer employed.

Advantageously, the coloring units may also be present in the kit according to the present disclosure in number of 10, 12 or even in a different number, being able to mix coloring units of different colors and dosages to obtain all the desirable color hues.

For example, the correlation will identify a recipe on the basis of which the user will be guided in the preparation of the sample paint, varnish or lacquer. Hence, the user will find for example a specific indication to add to the known quantity of base paint, varnish or lacquer the coloring units pre-dosed in the exact quantity indicated by the correlation/recipe.

For example, the user will find an indication to add to the specific quantity of base paint, varnish or lacquer, four doses of coloring units A, ten doses of coloring units B, plus one dose of coloring unit C to obtain the desired color.

It has been observed that the kit, the method, and the coloring unit to be employed in said method, for preparing a sample of paint, varnish or lacquer, colored according to the present disclosure, fulfils its task and accomplishes the pre-set purposes because it allows to obtain in an easy, independent, reliable and economic manner the preparation of reduced quantities of colored paint, colored varnish or colored lacquer avoiding needless waste of paint, varnish or lacquer and reducing the necessary times.

The disclosure thus conceived is susceptible to numerous modifications and variants, all falling within the scope of the inventive concept; moreover, all details are replaceable with other technically equivalent elements.

1. Kit for preparing a colored sample of paint, varnish or lacquer, particularly for selecting a desired color of a paint, varnish or lacquer, to be applied to a wall or to a support, comprising:
a main container containing a known amount of a base paint, lacquer or varnish to be colored, and
a set of coloring units, said coloring units being able to be mixed with said known amounts of base paint, varnish or lacquer to prepare a sample of colored paint, varnish or lacquer,
wherein each of said coloring units comprising at least one pre-dosed unit, said coloring units having a plurality of different colors.

2. Kit for preparing a colored sample of paint, varnish or lacquer according to the previous claim 1, wherein each of said pre-dosed units comprises a pre-dosed amount by weight and/or by volume of at least one coloring agent of a certain color.

3. Kit according to claim 1, wherein each of said pre-dosed units comprises several coloring agents of different colors each in a pre-dosed amount by weight and/or by volume.

4. Kit according to claim 1, wherein each pre-dosed unit is marked by a symbol and/or by a sign and/or by a reference adapted for univocally identifying said specific unit.

5. Kit according to claim 1, wherein said known amount of base paint, varnish or lacquer to be colored contained in said main container is less than 500 ml, preferably equal to 200 ml, even more preferably equal to 100 ml.

6. Coloring unit in the form of pre-dosed unit, able to be mixed with a base paint, varnish or lacquer for preparing a colored sample of paint, varnish or lacquer, comprising a pre-dosed unit by weight and/or by volume, of at least one coloring agent.

7. Coloring unit in the form of pre-dosed unit according to claim 6, wherein said pre-dosed unit comprises several coloring agents of different colors each in a pre-dosed amount by weight and/or by volume.

8. Coloring unit in the form of pre-dosed unit according to claim 6, wherein it is marked with a symbol and/or a sign and/or a reference adapted for univocally identifying said specific unit.

9. Coloring unit in the form of pre-dosed unit according to claim 6, comprising a tablet of powders or a predetermined volume of a paste or of a gel or liquid.

10. Coloring unit in the form of pre-dosed unit according to claim 6, wherein it is contained in a capsule that can be opened or perforated, or by a water-soluble support.

11. Coloring unit in the form of pre-dosed unit according to claim 6, wherein it comprising a sachet, or a water-soluble sachet.

12. Method for preparing a colored sample of paint, varnish or lacquer, particularly for selecting a desired color of a paint, varnish or lacquer to be applied to a wall or to a support, comprising the following steps:
providing a main container containing a known amount of a base paint, varnish or lacquer to be colored,
providing a set of coloring units wherein each of said coloring units comprising at least one pre-dosed unit and wherein said coloring units have a plurality of different colors;
selecting one or more of said coloring units of said set as a function of the desired color for said colored paint, varnish or lacquer;
adding and mixing said one or more selected coloring units to said base paint, varnish or lacquer contained in said main container.

13. Method for preparing a sample of colored paint, varnish or lacquer according to claim 12, wherein the step of selecting said one or more coloring units of said set of coloring units comprises the further step comprising previously identifying at least one desired final color among a plurality of sample colors, of associating each of said sample colors with a corresponding color/reference code, and of univocally associating each color/reference code with the number and type of said pre-dosed units that must be mixed with said base paint, lacquer or varnish to be colored.

14. Method for preparing a colored sample of paint, varnish or lacquer according to claim 12, wherein said pre-dosed unit is marked by a symbol and/or a mark and/or a reference adapted for univocally identifying said specific unit.
